(19) United States
(12) Patent Application Publication
(10) Pub. No.: US 2023/0312902 A1
(43) Pub. Date: Oct. 5, 2023

(54) PROCESSED MOLDED ARTICLE AND METHOD FOR PRODUCING THE SAME

(71) Applicant: Enplas Corporation, Saitama (JP)

(72) Inventor: Yihua SHEN, Saitama (JP)

(73) Assignee: Enplas Corporation, Saitama (JP)

(21) Appl. No.: 18/122,826

(22) Filed: Mar. 17, 2023

(30) Foreign Application Priority Data
Mar. 30, 2022 (JP) 2022-056285

(51) Int. Cl. C08L 33/02

(52) U.S. Cl. CPC C08L 33/02; C08L 2201/10; C08L 2201/08

(57) ABSTRACT

An object of the present invention is to provide a method for producing a processed molded article containing polylactic acid and having excellent transparency and excellent heat resistance. The method for producing a processed molded article of the present invention includes the following steps: preparing a molded article that contains polylactic acid containing an L-lactic acid unit at an amount of 99.0 mol % or more based on the total constituent units of the polylactic acid or a D-lactic acid unit at an amount of 99.0 mol % or more based on the total constituent units of the polylactic acid; and impregnating the molded article with carbon dioxide.

### CROSS REFERENCE TO RELATED APPLICATIONS

This application claims the benefit of priority of Japanese Patent Application No. 2022-056285, filed on Mar. 30, 2022, the disclosure of which including the specification, drawings and abstract is incorporated herein by reference in its entirety.

### TECHNICAL FIELD

The present invention relates to a processed molded article and a method for producing the processed molded article.

### BACKGROUND ART

Polylactic acid is derived from biomass and has biodegradability, thus has attracted a great deal of attention as a green material with low environmental impact. Although amorphous polylactic acid has high transparency, the heat resistance thereof is disadvantageously low. On the other hand, although crystalline polylactic acid has high heat resistance, the transparency thereof is disadvantageously low. In other words, it was difficult to obtain polylactic acid having both heat resistance and transparency, and applications of polylactic acid have been limited.

Therefore, various studies have been conducted to improve the heat resistance and transparency of polylactic acid. For example, Patent Literature (hereinafter, referred to as PTL) 1 discloses adding a hydroxyl group-containing fatty acid amide and a plasticizer with a specific structure to polylactic acid. In addition, PTL 2 discloses adding talc and a specific plasticizer to polylactic acid. Further, PTL 3 discloses adding a crystal nucleating agent containing basic zinc cyanurate and zinc phenylphosphonate to polylactic acid. Non Patent Literature (hereinafter, referred to as NPL) 1 describes impregnating polylactic acid with carbon dioxide.

### CITATION LIST

### Patent Literature

PTL 1 Japanese Patent Application Laid-Open No. 2013-122023
PTL 2 Japanese Unexamined Patent Application Publication (Translation of PCT Application) No. 2020-531677
PTL 3 Japanese Patent Application Laid-Open No. 2012-236867

### Non-Patent Literature

NPL 1 H. Marubayashi et al., “Crystalline Structure and Morphology of Poly(L-lactide) Formed under High-Pressure CO₂”, Macromolecules 2008, 41, 9192-9203

### SUMMARY OF INVENTION

### Technical Problem

A molded article of polylactic acid obtained as in PTLs 1 to 3 by using a crystal nucleating agent has transparency that lowers as the thickness increases, and thus further improvements have been required. In addition, with the technique described in NPL 1, the resulting molded article has a large haze.

An object of the present invention is to provide a processed molded article containing polylactic acid and having excellent transparency and excellent heat resistance, and also to provide a method for producing the processed molded article.

### Solution to Problem

The present invention provides a method for producing a processed molded article as follows.

A method for producing a processed molded article, the method including preparing a molded article that contains polylactic acid, the polylactic acid containing an L-lactic acid unit at an amount of 99.0 mol % or more based on the total constituent units of the polylactic acid or a D-lactic acid unit at an amount of 99.0 mol % or more based on the total constituent units of the polylactic acid; and impregnating the molded article with carbon dioxide.

The present invention provides a processed molded article as follows.

A processed molded article that contains polylactic acid containing an L-lactic acid unit at an amount of 99.0 mol % or more based on the total constituent units of the polylactic acid or a D-lactic acid unit at an amount of 99.0 mol % or more based on the total constituent units of the polylactic acid, in which the polylactic acid has a crystal size of 40 nm or less, and the processed molded article contains a crystal nucleating agent at an amount of 0.5 mass % or less.

### Advantageous Effects of Invention

A method for producing a processed molded article of the present invention can obtain a processed molded article containing polylactic acid and having excellent transparency and excellent heat resistance.

### BRIEF DESCRIPTION OF DRAWINGS

FIGS. 1A and 1B are schematic cross-sectional views for explaining a method for producing a processed molded article; and

FIG. 2A is a photograph of a processed molded article produced in Example 1, and FIG. 2B is a photograph of a processed molded article produced in Comparative Example 1.

### DESCRIPTION OF EMBODIMENTS

Hereinafter, a method for producing a processed molded article and the processed molded article will be described in detail based on specific embodiments. However, the method for producing a processed molded article and the processed molded article are not limited to the following embodiments.

1. Method for Producing Processed Molded Article

First, a method for producing a processed molded article according to one embodiment of the present invention will be described.

The method for producing a processed molded article in the present embodiment includes the following steps: preparing a molded article that contains polylactic acid, and the polylactic acid contains an L-lactic acid unit at an amount of 99.0 mol % or more based on the total constituent units of the polylactic acid or a D-lactic acid unit at an amount of 99.0 mol % or more based on the total constituent units of the polylactic acid (molded article preparation step); and impregnating the molded article with carbon dioxide (carbon dioxide impregnation step).

As described above, the transparency and heat resistance of polylactic acid are in a trade-off relationship, and conventionally, polylactic acid that satisfactorily has both of these properties has not been obtained. As a result of extensive studies, the present inventors found that by impregnating with carbon dioxide a molded article containing polylactic acid with a predetermined composition, a processed molded article having both high transparency and heat resistance can be obtained. The reason why a processed molded article having excellent transparency and heat resistance can be obtained by the producing method of the present embodiment is considered as follows.

First, in order to study the relationship between the crystal size and the light scattering property, the present inventors prepared a plurality of aqueous solutions in which silica particles having different particle sizes were dispersed, respectively, and irradiated the aqueous solutions with visible light. As a result, when the diameter of the silica particles is about 100 nm, Mie scattering occurs, but when the diameter of the silica particles is about 40 nm, the solution reaches a state close to Rayleigh scattering. This result suggests that reducing the crystal diameter of polylactic acid to about 40 nm can increase the transparency of the polylactic acid. Typically, a crystal nucleating agent is used for crystallizing polylactic acid. For adjusting the crystal diameter of polylactic acid to about 40 nm when a common crystal nucleating agent is used for crystallizing, the size of the nucleating agent should be set to several nanometers and the nucleating agent should be uniformly dispersed in the polylactic acid. However, such dispersion is very difficult. In addition, heating polylactic acid containing a crystal nucleating agent to a glass transition temperature (Tg) or higher can grow crystals; however, the typical heating temperature is 80 to 120° C., which more likely to increase the movement of molecular chains, and to increase the crystal size.

In the present embodiment, the amount of the L-lactic acid unit or the D-lactic acid unit in polylactic acid is set to 99.0 mol % or more. As a result, the crystallinity of polylactic acid (molded article) can be increased, and crystal nuclei are more likely to be generated in the polylactic acid by uniform nucleation without using a crystal nucleating agent. In the present embodiment, a molded article containing such polylactic acid is impregnated with carbon dioxide. This plasticizes the polylactic acid and temporarily lowers the glass transition temperature of the polylactic acid. As a result, crystallization becomes possible even in a low temperature range where achieving both nucleation and crystal growth should not normally be possible. At this time, due to the low temperature, the movement of the molecular chains is restricted, the increase of the crystal size is prevented, thereby forming a large number of fine crystals (having a diameter of 40 nm or less). This is considered to be the reason why the transparency of the obtained processed molded article is very high. Furthermore, the crystallization of the polylactic acid is considered to provide satisfactory heat resistance.

Hereinafter, each step of the method for producing a processed molded article according to the present embodiment will be described.

Molded Article Preparation Step

In the molded article preparation step, a molded article that contains polylactic acid containing the L-lactic acid unit at an amount of 99.0 mol % or more or the D-lactic acid unit at an amount of 99.0 mol % or more is prepared. The molded article may contain components other than polylactic acid within a range that does not impair the object and effect of the present embodiment, but the amount of polylactic acid in the molded article is preferably 80 mass % or more, more preferably 90 mass % or more. Moreover, the molded article preferably contains a crystal nucleating agent at an amount of 0.5 mass % or less, and is more preferably substantially free of crystal nucleating agents. An amount of the crystal nucleating agent of 0.5 mass % or less is more likely to allow the crystal size of polylactic acid to fall within a desired range (40 nm or less).

Polylactic acid may have any structure as long as lactic acid is polymerized through ester bonds. Lactic acid has an asymmetric carbon in the molecule, and thus has optical isomers. Specifically, there are L-lactic acid (hereinafter also referred to as “L-isomer”) and D-lactic acid (hereinafter also referred to as “D-isomer”). In common polylactic acid, L-isomer and D-isomer are often mixed, but in the present embodiment, the amount of either L-isomer or D-isomer in polylactic acid is 99.0 mol % or more based on the total constituent units of the polylactic acid. The amount of the L-isomer or D-isomer in the polylactic acid is preferably 99.4 mol % or more, more preferably 99.6 mol % or more, based on the total constituent units of the polylactic acid. When the amount of either the L-isomer or the D-isomer in the polylactic acid is 99.0 mol % or more based on the total constituent units of the polylactic acid, crystal nuclei are more likely to be formed as described above.

The amount of L-isomer and D-isomer in polylactic acid can be adjusted by selecting the materials to be used for synthesizing the polylactic acid. Polylactic acid is obtained, for example, by ring-opening polymerization of lactide of lactic acid. By adjusting the ratio of L-lactide to D-lactide, the amounts of L-isomer and D-isomer in polylactic acid can be adjusted. The ring-opening polymerization of the lactide may be carried out by a known method, such as polymerization carried out by mixing a catalyst and/or a polymerization initiator with the lactide.

The weight average molecular weight of the polylactic acid contained in the molded article is preferably 50,000 or more and 300,000 or less, more preferably 70,000 or more and 250,000 or less. A weight average molecular weight of polylactic acid of 50,000 or more is more likely to increase the mechanical strength of an obtained processed molded article. A weight average molecular weight of 300,000 or less is more likely to allow molding of an article into a desired shape. The weight average molecular weight of polylactic acid (as a styrene equivalent value) is measured by gel permeation chromatography.

The shape of a molded article prepared in the present step is not limited, and is appropriately selected according to the application or the like of the processed molded article. The molded article may have a shape of, for example, a film, a sheet, a plate, or a flat plate. Alternatively, a molded article may have a three-dimensional shape as long as the shape allows the molded article to be impregnated with the carbon dioxide in the impregnation step to be described below. In addition, a molded article obtained from conventional polylactic acid has transparency that tends to decrease as the thickness of the molded article increases. However, the method for producing a processed molded article of the present embodiment can satisfactorily increase the transparency of the molded article (processed molded article) even when the thickness of the molded article is 500 μm or more.

The molded article to be prepared in the present step may be a commercially available product as long as the amount of the L-isomer or the amount of the D-isomer in the polylactic acid is within the above range. However, as described above, common polylactic acid normally include less than 99.0 mol % of L-isomer and less than 99.0 mol % of D-isomer. Pellets or the like of polylactic acid having a desired composition thus may be prepared and molded.

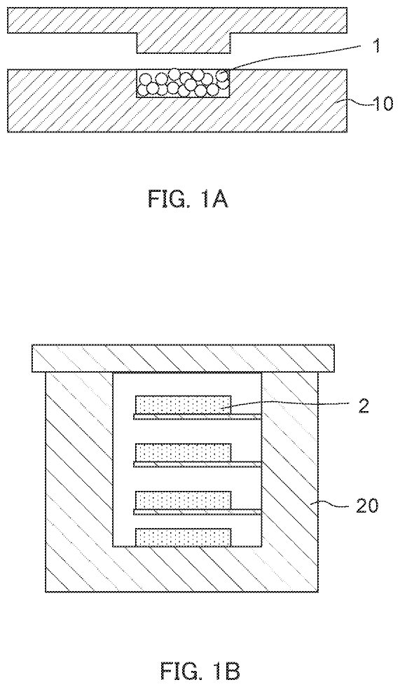

Any method may be used for molding polylactic acid. For example, as illustrated in FIG. 1A, pellets 1 of desired polylactic acid may be prepared and molded by using mold 10 or the like. The polylactic acid may also be molded by injection molding, blow molding, extrusion molding, or the like. The polylactic acid may be formed into a sheet, and then subjected to vacuum molding, pressure molding, vacuum pressure molding, or the like.

Carbon Dioxide Impregnation Step

In the carbon dioxide impregnation step, the molded article is impregnated with carbon dioxide. Specifically, as illustrated in FIG. 1B, molded articles 2 are placed in pressure vessel 20. Gaseous carbon dioxide is supplied into pressure vessel 20 from a fluid supply device (not illustrated) connected to pressure vessel 20. Although carbon dioxide in a liquid form or a supercritical form may be supplied into pressure vessel 20, it is preferred that pressure vessel 20 is filled with gaseous carbon dioxide that is then compressed to obtain a high pressure gaseous carbon dioxide. Carbon dioxide is easier to handle in gaseous form than in liquid form or supercritical form.

By filling pressure vessel 20 with carbon dioxide and applying pressure, molded article 2 is impregnated with carbon dioxide. As a result, the polylactic acid is plasticized and the glass transition temperature is lowered as described above. The time for impregnating molded article 2 with carbon dioxide is not limited, but is preferably 30 minutes or longer, more preferably 45 minutes or longer. Impregnation time of 30 minutes or more can satisfactorily lower the glass transition temperature of the polylactic acid. On the other hand, the upper limit of the impregnation time is not limited, but the impregnation time is preferably within 5 hours from the viewpoint of the production efficiency of the processed molded article.

In addition, the temperature during the impregnation with carbon dioxide is not limited, but is preferably equal to or higher the melting point of carbon dioxide and lower than room temperature. The pressure during the impregnation with carbon dioxide is not limited either as long as the pressure is equal to or higher than the atmospheric pressure. On the other hand, although the upper limit of the pressure is not limited, it is appropriately selected according to the performance of the pressure vessel.

After a certain period of time passes, molded article 2 is taken out from pressure vessel 20 and the carbon dioxide in the polylactic acid is removed to obtain a processed molded article. The carbon dioxide may be removed by, for example, leaving molded article 2 taken out from pressure vessel 20 at room temperature, but annealing treatment may be performed as necessary. The temperature during the annealing treatment is preferably 60° C. or higher and 140° C. or lower. The time for annealing treatment is preferably about 10 minutes to 120 minutes. Carbon dioxide can be removed efficiently by annealing.

2. Processed Molded Article

A processed molded article according to one embodiment of the present invention will be described. The processed molded article contains polylactic acid that contains an L-lactic acid unit at an amount of 99.0 mol % or more based on the total constituent units of the polylactic acid or a D-lactic acid unit at an amount of 99.0 mol % or more based on the total constituent units of the polylactic acid. The processed molded article may contain components other than polylactic acid within a range that does not impair the object and effect of the present embodiment, but the amount of polylactic acid in the processed molded article is preferably 90 mass % or more. It is more preferred that substantially all of the processed molded article is composed of polylactic acid.

Moreover, the processed molded article preferably contains a crystal nucleating agent at an amount of 0.5 mass % or less, and is more preferably substantially free of crystal nucleating agents. Setting the amount of the crystal nucleating agent to 0.5 mass % or less can adjust the crystal size of polylactic acid to 40 nm or less.

The crystal size of the polylactic acid in the processed molded article is 40 nm or less, preferably 30 nm or less. The crystal size of polylactic acid can be determined by transmission electron microscopy or wide-angle X-ray diffraction. When the crystal size of polylactic acid in the processed molded article is 40 nm or less, it is sufficiently smaller than the wavelength of visible light, so Mie scattering is less likely to occur, and the transmittance of visible light is greatly increased.

The degree of crystallinity of the polylactic acid determined by differential scanning calorimetry is preferably 30 to 60%, more preferably 40 to 60%. A degree of crystallinity of polylactic acid of 30% or more is more likely to increase the heat resistance of the polylactic acid. On the other hand, the upper limit of the degree of crystallinity of polylactic acid is usually about 60%.

The shape of the processed molded article is not limited, and is appropriately selected according to the application thereof. The processed molded article may be obtained by further processing a processed molded article produced by the method for producing a processed molded article described above.

It is preferred that the processed molded article has transmittance of light (having a wavelength of 400 nm) of 80% or more. In general, the shorter the wavelength of light, the more easily Mie scattering occurs, thereby lowers the transmittance of the light. Therefore, it can be said that when the transmittance of light having a wavelength of 400 nm is satisfactorily high, Mie scattering is less likely to occur for the entire visible light. Furthermore, when the transmittance of light having a wavelength of 400 nm is 80% or more, the processed molded article can be used for various applications.

The processed molded article may be used in any application. The processed molded article can be applied to a wide variety of applications, for example, an application requiring transparency, such as for disposable products for optical inspection, various containers, and packaging materials.

### EXAMPLES

Hereinafter, the present invention will be described with reference to Examples and Comparative Examples; however, the present invention is not limited to the following Examples.

(1) Preparation of Polylactic Acid

Pellets of polylactic acid were prepared for use in the Examples and Comparative Examples described below.

L-1: Grade L130 manufactured by TotalEnergies Corbion

L-2: Polylactic acid prepared in Synthesis Example 1 below

L-3: 3001D manufactured by NatureWorks

L-4: 3052D manufactured by NatureWorks

D-1: Polylactic acid prepared in Synthesis Example 2 below

### Synthesis Example 1

A reaction vessel equipped with a stirrer was charged with 99.0 parts by mass of L-lactide, 1.0 part by mass of D-lactide, a catalyst (tin octylate), and a polymerization initiator (lauryl alcohol). The lactides (L-lactide and D-lactide) were melted at 110° C. and stirred for 30 minutes. Further, the temperature was raised to 160° C., stirring was stopped, the temperature was lowered to 130° C., the pressure was reduced, and unreacted lactides (L-lactide and D-lactide) were removed. The resulting mixture was dissolved in chloroform and reprecipitated in methanol to obtain a purified product. By IR spectrum (infrared absorption spectrum) measurement, it was confirmed that the absorption peak of hydroxyl groups at a wave number of around 3400 cm⁻¹ had disappeared. Polylactic acid (L-1) was thus obtained. The amount of the L-lactic acid unit in the obtained polylactic acid was 99.0 mol %, and the amount of the D-lactic acid unit was 1.0 mol %.

### Synthesis Example 2

Polylactic acid (D-2) was obtained in the same manner as in Synthesis Example 1, except that the ratio of L-lactide to D-lactide was 0.6 parts by mass to 99.4 parts by mass. In the polylactic acid obtained by this method, the amount of the L-lactic acid unit was 0.6 mol %, and the amount of the D-lactic acid unit was 99.4 mol %.

(2) Molding of Polylactic Acid and Impregnation of Molded Article with Carbon Dioxide

As illustrated in FIG. 1A, pellets 1 of each polylactic acid was processed under the conditions of a temperature of 200° C. and a pressure of 5.0 MPa by using mold 10 to obtain circular molded article 2 having a diameter of 30 mm and a thickness of 1 mm.

Next, obtained molded article 2 was placed in pressure vessel 20 as illustrated in FIG. 1B. Then, the pressure vessel was filled with carbon dioxide. Inside the vessel, the temperature was set to 0° C., and the pressure was set to 3 MPa. Thereby, molded article 2 was impregnated with carbon dioxide. The impregnation time was set to 2 hours.

Subsequently, the molded article was taken out from the pressure vessel and annealed at 100° C. for 60 minutes under atmospheric pressure.

(3) Evaluation
Measurement of Degree of Crystallinity

The degree of crystallinity of the circular pressed sheet (processed molded article) after the processing was determined by differential scanning calorimetry (DSC). A sample for measurement (with weight of 5 to 8 mg) from the circular pressed sheet was placed in an aluminum pan, charged into the DSC measurement section, and then heated to 220° C. at a rate of 10° C./min. Crystallization enthalpy (ΔHc) and crystal melting enthalpy (ΔHm) were measured, and (ΔHm−ΔHc)×100% was used as the degree of crystallinity. Results are shown in Table 1.
Measurement of Crystal Size

The circular pressed sheet was cut in a direction (a) parallel to the radial direction and perpendicular to the sheet surface (axial direction), and a direction (b) parallel to the radial direction and perpendicular to the circumferential direction by using the ultramicrotomy to prepare samples for observation. Each sample was dyed with ruthenium tetroxide, and a photograph of the cut surface was taken with a transmission electron microscope at a magnification of 120,000. When crystals did not exist as island components, the crystal size was determined by wide-angle X-ray diffraction with the use of the Scherrer equation.

When crystals exist as island components, the obtained photograph is read into image processing software, 10 island components are selected at random, image processing is performed, and the size of the island components is calculated as described below.

The major axis (1a) and minor axis (1b) of an island component appeared on the cut surface in the direction (a) and the major axis (1c) and minor axis (1d) of an island component appeared on the cut surface in the direction (b) were obtained. Furthermore, the crystal size was defined by the equation, (I+J)/2, based on the following equations: shape factor I of island component=(average value of 1a+average value of 1b)/2; and shape factor J=(average value of 1c+average value of 1d)/2. Results are shown in Table 1.
Measurement of Heat Resistant Temperature

The heat resistant temperature of the circular pressed sheet (processed molded article) after the processing was determined by dynamic viscoelasticity measurement. Specifically, a rectangle sample with a length of 14 mm, a width of 3 mm, and a thickness of 1 mm was cut out from the circular pressed sheet, fixed to the measurement section of a dynamic viscoelasticity measuring device. At a heating rate of 10° C./min, the temperature at which the storage elastic modulus decreased to 180 MPa was used as the heat resistant temperature. Results are shown in Table 1.
Transmittance and Scattering Rate of Light having Wavelength of 400 nm

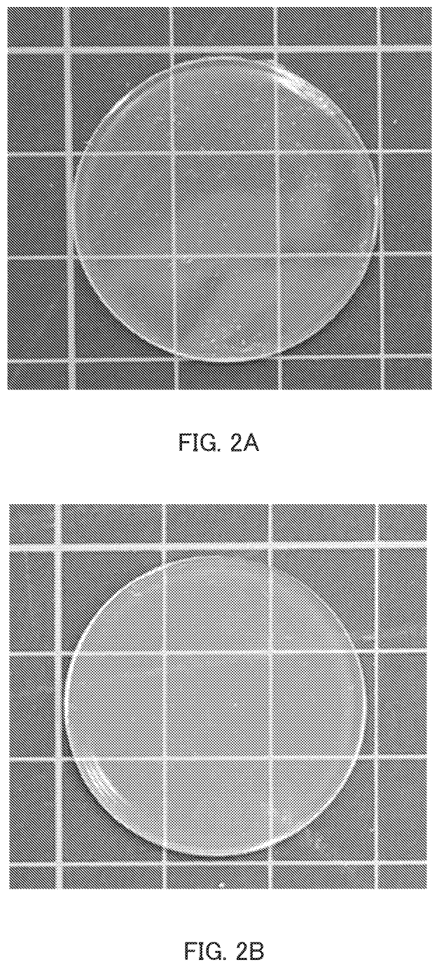

The transmittance and scattering rate of light having a wavelength of 400 nm were measured with an ultraviolet-visible spectrophotometer equipped with an integrating sphere. The scattering rate was defined by the following equation: (luminous flux of scattering component/total luminous flux of transmission)×100%. Results are shown in Table 1. FIGS. 2A and 2B show photographs of the circular pressed sheets (processed molded articles) after the processing in Example 1 and Comparative Example 1.

TABLE 1

| | | EX. | EX. | EX. | Comp. | Comp. |
|---|---|---|---|---|---|---|
| | | 1 | 2 | 3 | EX. 1 | EX. 2 |
| Poly- | L-1 | ◯ | | | | |
| lactic | (L-isomer 99.6 mol %, | | | | | |
| acid | D-isomer 0.4 mol %) | | | | | |
| | L-2 | | ◯ | | | |
| | (L-isomer 99.0 mol %, | | | | | |
| | D-isomer 1.0 mol %) | | | | | |
| | L-3 | | | | ◯ | |
| | (L-isomer 98.6 mol %, | | | | | |
| | D-isomer 1.4 mol %) | | | | | |
| | L-4 | | | | | ◯ |
| | (L-isomer 95.8 mol %, | | | | | |
| | D-isomer 4.2 mol %) | | | | | |
| | D-1 | | | ◯ | | |
| | (L-isomer 0.4 mol %, | | | | | |
| | D-isomer 99.6 mol %) | | | | | |
| Carbon | Pressure (MPa) | 3 | 3 | 3 | 3 | 3 |
| dioxide | Temperature (° C.) | 0 | 0 | 0 | 0 | 0 |
| | Impregnation time (hour) | 2 | 2 | 2 | 2 | 2 |
| Eval- | Degree of crystallinity (%) | 44 | 40 | 42 | 38 | 21 |
| uation | Heat resistant | 123 | 115 | 121 | 90 | 65 |
| | temperature (° C.) | | | | | |
| | Crystal size (nm) | 18 | 24 | 21 | 45 | 104 |
| | Transmittance (%) | 85 | 83 | 84 | 81 | 70 |
| | of light with | | | | | |
| | wavelength of 400 nm | | | | | |
| | Scattering Rate (%) | 6 | 9 | 8 | 19 | 42 |
| | of light with | | | | | |
| | wavelength of 400 nm | | | | | |

As shown in Table 1, when the amount of the L-lactic acid unit was 99.0 mol % or more based on the total constituent units of polylactic acid (Examples 1 and 2), or when the amount of the D-lactic acid unit was 99.0 mol % or more based on the total constituent units of polylactic acid (Example 3), the degree of crystallinity exceeded 40% and the heat resistant temperature was high. In addition, the transmittance of light having a wavelength of 400 nm was high, and the scattering rate of the light was low; thus, it can be said that the Examples achieved both high heat resistance and high transparency. The reason therefor is considered that the crystal size was 40 nm or less and the degree of crystallinity was high as shown in Table 1.

On the other hand, when the amounts of both the L-lactic acid unit and the D-lactic acid unit in the polylactic acid were less than 99.0 mol % (Comparative Examples 1 and 2), the degree of crystallinity was low and the crystal size was not sufficiently reduced even when a molded article was produced or impregnated with carbon dioxide under the same conditions. As a result, the heat resistant temperature was low and the transmittance of light having a wavelength of 400 nm was also low.

### Industrial Applicability

The method for producing a processed molded article according to the present embodiment is particularly advantageous for, for example, producing a processed molded article applicable in a wide variety of applications, such as for disposable products for optical inspection, various containers, and packaging materials.

### REFERENCE SIGNS LIST

1 Pellet
2 Molded article
10 Mold
20 Pressure vessel

1. A method for producing a processed molded article, the method comprising:
preparing a molded article that contains polylactic acid, the polylactic acid containing an L-lactic acid unit at an amount of 99.0 mol % or more based on a total constituent unit of the polylactic acid or a D-lactic acid unit at an amount of 99.0 mol % or more based on the total constituent unit of the polylactic acid; and
impregnating the molded article with carbon dioxide.

2. The method according to claim 1, wherein
in the impregnating of the molded article with the carbon dioxide, impregnation time is 30 minutes or longer.

3. A processed molded article, comprising:
polylactic acid that contains an L-lactic acid unit at an amount of 99.0 mol % or more based on a total constituent unit of the polylactic acid or a D-lactic acid unit at an amount of 99.0 mol % or more based on the total constituent unit of the polylactic acid, wherein
the polylactic acid has a crystal size of 40 nm or less, and
the processed molded article contains a crystal nucleating agent at an amount of 0.5 mass % or less.

4. The processed molded article according to claim 3, wherein
the polylactic acid has a degree of crystallinity of 30 to 60%, the degree of crystallinity being determined by differential scanning calorimetry.

5. The processed molded article according to claim 3, wherein
the processed molded article has transmittance of light of 80% or more, the light having a wavelength of 400 nm.
